(19) United States
(12) Patent Application Publication
(10) Pub. No.: US 2013/0252690 A1
(43) Pub. Date: Sep. 26, 2013

(54) REAL ESTATE HOUSING LOTTERY

(71) Applicant: Dempsey Addision, Detroit, MI (US)

(72) Inventor: Dempsey Addision, Detroit, MI (US)

(21) Appl. No.: 13/840,333

(22) Filed: Mar. 15, 2013

Related U.S. Application Data
(60) Provisional application No. 61/614,073, filed on Mar. 22, 2012.

(51) Int. Cl. G06Q 50/16

(52) U.S. Cl. CPC G06Q 50/16
USPC 463/17

(57) ABSTRACT

A method disclosed for a lottery to transfer legal title in government owned properties to the public. In the method the legal title to at least one qualifying structure is offered up as a prize in the lottery. A qualifying structure being, preferably, a structure that has been inspected for compliance with all building codes and building occupancy rules, laws, and regulations. Entries to the lottery may then be distributed and a winner selected. In the method, the lottery winner receives title to the property and, preferably, at least one of a tax benefit or an insurance benefit related to the structure.

### CROSS-REFERENCE TO RELATED APPLICATIONS

This Application claims the benefit of U.S. Provisional Application 61/614,073 filed on Mar. 22, 2012, the contents of which are incorporated herein by reference in its entirety.

### BACKGROUND OF THE INVENTION

1. Field of the Invention

A real estate lottery is disclosed in which a lottery winner may be awarded title to a structure and, for a predetermined period of time, certain tax breaks and insurance related to the structure.

2. Reference to Related Art

A variety of different real estate lotteries have been used in the past to transfer residential housing to individuals. In 2009, for example, the Orange County Community Housing Corporation held a lottery in which three homes were offered as prizes to qualifying low income families. The three homes were not given away. They were sold to the winners on favorable terms in which Neighborhood Housing Services of Orange County functioned as the processor for the buyer's loans and escrows.

In another form of lottery an individual may attempt to sell a residential structure by offering tickets priced at a percentage of the preferred purchase for the structure. For example, an individual wishing to sell his or her home for $150,000 may attempt to sell 1,500 lottery tickets at a price of $100.00 per ticket.

In still another type of lottery a number of lottery “finalists” for a residential structure are first preselected by a blind draw. The winner of the lottery, and the structure, is then selected based on a blind draw from among the finalists.

Clearly absent from these known forms of real estate lotteries is at least some confirmation for the winner that the structure involved is both safe and habitable. Moreover, while these known lotteries all result in the transfer of housing, a problem exists in that even if an individual is lucky enough to win, the winner's economic circumstances may still be dire. And, as a result, over a short period of time the accumulation of unpaid taxes, non-existence and/or insufficient insurance (or the like) may make it difficult (or impossible) for the winner to actually remain in the structure. Therefore, it would be advantageous to have a real estate lottery that also includes a process to assist the winner(s) to actually stay in the structure for the long term.

### SUMMARY OF THE INVENTION

A real estate lottery is disclosed in which a lottery winner may be awarded clear legal title to a residential structure and, for a predetermined period of time, certain tax breaks and insurance related to the structure. The disclosed real estate lottery may have the positive effect of creating jobs in the community, rebuilding and stabilizing neighborhoods, providing revenue for government, immediate placement of new occupants in vacant and/or foreclosed structures, and/or reducing government debt.

In the disclosed lottery, a unit of government (such as national, state or municipal government, political subdivisions thereof, and quasi-governmental organizations) that holds legal title to at least one qualifying structure offers up that title as a lottery prize. The structure, however, will have preferably first been inspected by the governmental unit or an agent thereof for compliance with all applicable building codes and building occupancy rules, laws, and regulations.

Entries to the lottery may then be distributed to the public, and in at least one embodiment, to qualified individuals who agree to certain terms. The requisite terms may be in addition to standard lottery regulations and may include an agreement that—should the entrant win—he or she will live in the structure for a period of years (e.g., five years). Distribution of entries to the lottery may, for example, take the form of traditional paper tickets, virtual (computer/Internet based) entries, the submission of entry information (registration information) by an individual into a computer database, or combinations thereof. Where virtual entries and/or entry by electronic registration are provided for it will be appreciated that distribution of entries may be facilitated by the use of one or more computer servers that possess the requisite commercially available registration software, memory unit(s), data processing unit(s), and communications unit(s) so that the server may transmit and receive data (e.g., entries) from and to the server. For example, U.S. Pat. No. 8,280,767 (the disclosure of which is incorporated by reference herein in its entirety) discloses a lottery system using electronic mail.

After all available entries are distributed and/or the passage of a predetermined amount of time, at least one entry is selected as a winner of the prize with the result that the prize/title is transferred from the governmental unit to the winner (subject to any terms of the lottery (as discussed supra)).

In addition, the unit of government may provide the winner with at least one of a tax benefit or an insurance benefit related to the associated structure so that the winner is further induced and/or assisted to follow-through on the terms of the lottery.

### BRIEF DESCRIPTION OF THE DRAWINGS

Reference will be made herein to the attached drawing wherein like reference numerals refer to like parts throughout and wherein:

FIG. 1 is a flowchart view of a method of providing a real estate lottery.

### DETAILED DESCRIPTION OF THE PREFERRED EMBODIMENTS

A method 100 for a real estate lottery is disclosed in which a lottery winner may be awarded title to a structure and, for a predetermined period of time, may also be awarded certain tax and/or insurance benefits related to the structure. The real estate lottery may be operated by a unit of government (e.g., a national, state and/or municipal government, political subdivisions thereof or a quasi-governmental entity (e.g., community land banks or the like)) to dispose of (e.g., surplus) housing stock owned by the unit of government. Additionally, the lottery may include title to structures held by a non-government unit (e.g., private entities such as mortgage companies, banks, and other lending institutions that hold title to housing in local municipalities). When used on a larger scale involving many properties, such as may be the case for a real estate lottery operated by a municipality and or state government, the real estate lottery may function to create jobs, rebuild and stabilize neighborhoods, provide revenues for the state and municipality, restore vacant or foreclosed houses for immediate occupancy, and reduce the debt load of local governments.

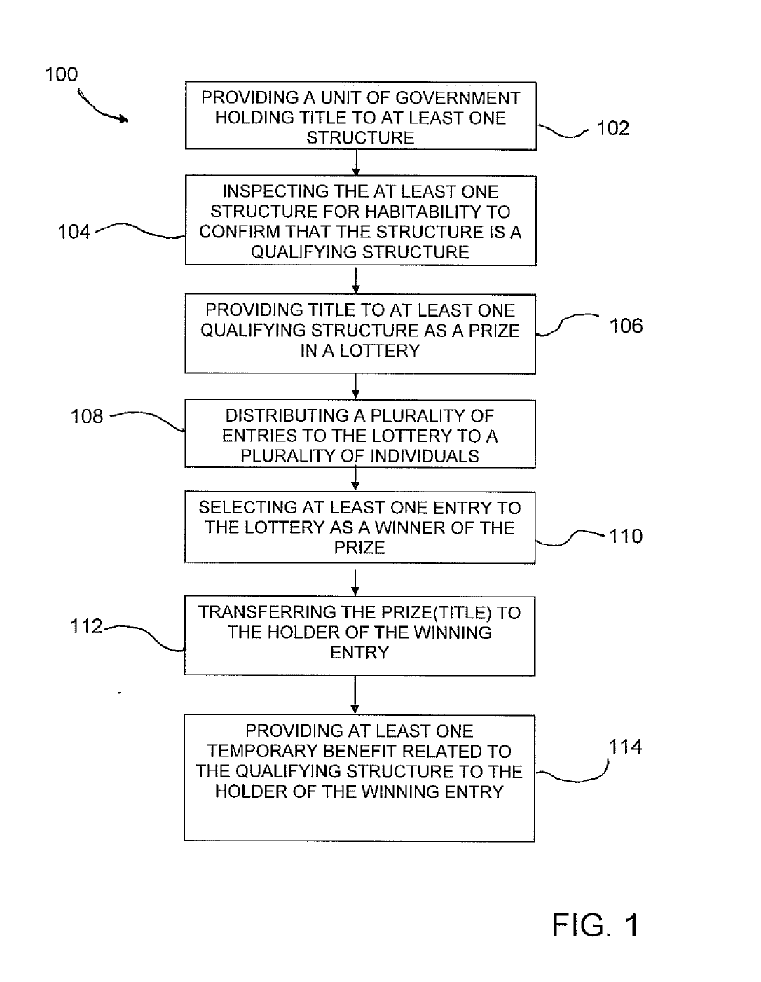

Referring now to FIG. 1, the method 100 for a real estate lottery may involve providing a unit of government that owns/holds title to at least one structure 102 that may be offered up as a prize in the lottery. In addition, an important consideration is that each title/structure offered up as a prize be inspected to ensure that it is habitable 104 and in condition for immediate occupancy. More specifically, in order to be a qualifying structure for which the title is offered up as a prize the structure should be prescreened prior to placement in the lottery for compliance with all building codes and building occupancy rules, laws, and regulations. In one embodiment of the method 100, the structure(s) may be a qualifying residential structure such as a single family residence. It will be appreciated, however, that the title to other qualifying residential structures as mobile homes, duplex housing, condominiums or the like may also be offered up as a prize(s).

Still referring to FIG. 1, in one embodiment, once the structure is deemed a qualifying structure the title to the structure(s) is provided as a prize in the lottery 106. Ordinarily, the title to only one structure is offered as a prize in each lottery drawing. To that end, entries/tickets in a lottery for a particular title/residential structure may be offered only for a predetermined period of time—such as one (1) month. It will, however, be appreciated that a lottery drawing may be held in a greater or lesser period of time. For example, a municipality that owns a large amount of qualifying housing may hold a daily or weekly lottery.

Next, entries to the lottery are distributed/sold to a plurality of individuals 108—such as the general public. The price for each ticket in a lottery may be predetermined by, for example, the inventor and the operator of the lottery, or exclusively by the unit of government. However, so that individuals having the greatest economic need, but the least economic means, may participate in the lottery it is preferred that the entry price be set low—such as $1 or $2—and without regard to an appraised value of the involved title/structure. Although, it will be appreciated that entries may be sold for a greater or lesser amount.

The distribution of entries/tickets in the lottery may take the form of the sale of traditional paper tickets, virtual (computer/internet based) entries, the submission of entry information (registration information) by an individual into a computer database, or a combination thereof. Where virtual entries and/or entry by registration are provided it will be appreciated that distribution may be facilitated by the use of one or more computer servers that possess the requisite commercially available software, memory unit(s), data processing unit(s), and communications unit(s) so that the server may transmit and receive data (e.g., entries) from and to the server.

It will be appreciated that each purchasers/holder of an entry in the lottery 10 may be a qualifying individual who meets certain predetermined requirements/terms set by the lottery. These requirements/terms may be beyond those required by the applicable and standard lottery laws and regulations. For example, in order to purchase or validly hold an entry in the lottery the purchaser/holder must agree to live in the structure for a period of years (e.g., five years) that—should he or she win.

Still referring to FIG. 1, next, at least one entry into the lottery is selected as a winner of the lottery prize 110. The winner of the lottery may be selected using a range of methods including by blind draw, random electronic selection, or the like using selection processes known in the art.

Still referring to FIG. 1, after a lottery winner has been selected, the prize/title is transferred to the holder of the winning entry 112. More particularly, upon presentation of a winning entry/ticket, a lottery winner is awarded legal title to the structure(s) associated with the applicable drawing subject to fulfillment of the requirements/terms set by the lottery (e.g., residency requirements).

Still referring to FIG. 1, another important consideration is that at least temporary benefit related to the property/qualifying structure be provided to the winner 114. Such a benefit(s) may include a rebate or abatement for all taxes related to the structure for a predetermined number of years. Additionally, or alternatively, the benefit may include prepaid homeowners insurance. In one embodiment, the tax and/or insurance benefits are offered for a period of five years. It will, however, be appreciated that a greater or lesser period of time may also be used in connection with the offering of the tax abatement and homeowners insurance.

Having thus described the invention, various other embodiments will become apparent to those of skill in the art that do not depart from the scope of the appended claims.

I claim:

1. A method comprising:
providing as a prize in a lottery the legal title to at least one qualifying structure, the qualifying structure having been inspected for compliance with all building codes and building occupancy rules, laws, and regulations;
distributing a plurality of tickets for the lottery;
selecting a ticket as a winner of the lottery;
transferring the legal title to a holder of the winning lottery ticket;
providing to the holder of the winning lottery ticket at least one of a tax benefit or an insurance benefit related to the prize.

2. The method of claim 1, wherein the at least one qualifying structure is a single family home.

3. The method of claim 1, wherein the at least one qualifying structure is selected from a group consisting of a mobile home, a duplex housing unit, and a condominium.

4. The method of claim 1, wherein the at least one qualifying structure is owned by a unit of government.

5. The method of claim 4, wherein the unit of government is a state government.

6. The method of claim 4, wherein the unit of government is a municipal government.

7. The method of claim 1, wherein the at least one qualifying structure comprises a plurality of residential structures.

8. The method of claim 7, wherein the plurality of residential structures includes at least one government owned structure and at least one structure owned by a non-governmental entity.

9. The method of claim 8, wherein the non-governmental entity comprises a mortgage company.

10. A method comprising:
providing a unit of government, the unit of government holding legal title to at least one qualifying residential structure, the qualifying residential structure having been inspected for compliance with all building codes and building occupancy rules, laws, and regulations
providing as a prize in a lottery legal title to the at least one qualifying residential structure;
distributing a plurality of entries to the lottery to a plurality of individuals;
selecting at least one entry to the lottery as a winner of the prize;
transferring the prize to the holder of the winning entry to the lottery;
providing to the holder of the winning entry to the lottery at least one of a tax benefit or an insurance benefit related to the qualifying residential structure.

11. The method of claim 10, wherein the at least one qualifying residential structure is a single family home.

12. The method of claim 10, wherein the at least one qualifying residential structure is selected from a group consisting of a mobile home, a duplex housing unit, and a condominium.

13. The method of claim 12, wherein the unit of government is a state government.

14. The method of claim 12, wherein the unit of government is a municipal government.

15. The method of claim 10, wherein the at least one qualifying residential structure comprises a plurality of residential structures.

16. The method of claim 15, wherein the plurality of residential structures includes at least one government owned structure and at least one structure owned by a non-governmental entity.

17. The method of claim 16, wherein the non-governmental entity comprises a mortgage company.

18. A method comprising:
providing a unit of government, the unit of government holding legal title to at least one qualifying structure, the qualifying structure having been inspected for compliance with all building codes and building occupancy rules, laws, and regulations;
providing as a prize in a lottery legal title to the at least one qualifying structure;
distributing a plurality of entries to the lottery to a plurality of individuals;
selecting at least one entry to the lottery as a winner of the prize;
transferring the prize to the holder of the winning entry to the lottery;
providing to the holder of the winning entry to the lottery at least one temporary benefit related to the qualifying residential structure.

19. The method of claim 18, further comprising:
a computer server comprising a memory unit, data processing unit, and communications unit capable of transmitting and receiving data from and to the server; and
the plurality of entries to the lottery comprising virtual entries that are distributed from and received by the computer server.

20. The method of claim 18, wherein each individual in the plurality of individuals is a qualifying individual.
